(19) United States
(12) Patent Application Publication
(10) Pub. No.: US 2026/0299475 A1
(43) Pub. Date: Oct. 1, 2026

(54) IMAGE FORMING APPARATUS, NON-TRANSITORY COMPUTER READABLE MEDIUM STORING IMAGE FORMING PROGRAM, AND IMAGE FORMING SYSTEM

(71) Applicant: FUJIFILM Business Innovation Corp., Tokyo (JP)

(72) Inventors: Yuki ANDO, Kanagawa (JP); Tetsuhiro INOUE, Kanagawa (JP)

(73) Assignee: FUJIFILM Business Innovation Corp., Tokyo (JP)

(21) Appl. No.: 19/264,892

(22) Filed: Jul. 10, 2025

(30) Foreign Application Priority Data
Mar. 26, 2025 (JP) 2025-051871

(51) Int. Cl. G03G 15/00

(52) U.S. Cl. CPC G03G 15/50

(57) ABSTRACT

An image forming apparatus includes an image forming unit that forms an image on a recording medium under a predetermined condition, a correction unit that obtains a correction amount of the condition in accordance with a reading result of the image formed on the recording medium and corrects the condition, and a storage unit that stores the correction amount, in which the storage unit stores the correction amount obtained at a start of a job of the image forming unit and applies the correction amount at a start of a subsequent job.

### CROSS-REFERENCE TO RELATED APPLICATIONS

This application is based on and claims priority under 35 USC 119 from Japanese Patent Application No. 2025-051871 filed Mar. 26, 2025.

### BACKGROUND

### (i) Technical Field

The invention relates to an image forming apparatus, a non-transitory computer readable medium storing an image forming program, and an image forming system.

### (ii) Related Art

In the related art, for example, techniques disclosed in JP2019-074586A and JP2023-025581A have been suggested as a technique related to an image forming apparatus.

JP2019-074586A discloses a configuration including a control portion that provides a front-rear deviation correction amount for correcting a front-rear deviation occurring in forming an image on a front side and a rear side of a recording medium, in which the control portion is configured to provide the front-rear deviation correction amount corresponding to a characteristic of an output image. The control portion has one or more of a type of the recording medium, a size, a weight, and a fixing temperature of the recording medium, a recording medium supply tray, and an environment as a printing condition in providing the front-rear deviation correction amount.

JP2023-025581A discloses a configuration including a correction processing unit that executes correction processing of forming an adjustment image for adjusting a position of an image on a sheet via a forming portion and creating correction information for adjusting the position of the image formed by the forming portion based on a deviation amount of the position of the image measured from the adjustment image, an estimation unit that estimates the correction information based on information about an apparatus acquired from an image forming apparatus using a learning model that learns the correction information created through the correction processing and the information about the apparatus from the image forming apparatus as learning data, and a control unit that adjusts the position of the image formed by the forming portion based on the correction information estimated by the estimation unit.

### SUMMARY

Aspects of non-limiting embodiments of the present disclosure relate to an image forming apparatus, a non-transitory computer readable medium storing an image forming program, and an image forming system that enable correction appropriate for a recording medium immediately after the start of a subsequent job compared to a case where a correction amount obtained in finishing a job is stored and applied in starting the subsequent job.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including an image forming unit that forms an image on a recording medium under a predetermined condition, a correction unit that obtains a correction amount of the condition in accordance with a reading result of the image formed on the recording medium and corrects the condition, and a storage unit that stores the correction amount, in which the storage unit stores the correction amount obtained at a start of a job of the image forming unit and applies the correction amount at a start of a subsequent job.

### BRIEF DESCRIPTION OF THE DRAWINGS

Exemplary embodiment(s) of the present invention will be described in detail based on the following figures, wherein:

FIG. 1 is a schematic diagram illustrating an overall configuration of an image forming apparatus to which an image forming program according to Exemplary Embodiment 1 of the invention is applied;

FIG. 2 is a schematic diagram illustrating the overall configuration of the image forming apparatus to which the image forming program according to Exemplary Embodiment 1 of the invention is applied;

FIG. 3 is a configuration diagram illustrating an image forming portion of the image forming apparatus to which the image forming program according to Exemplary Embodiment 1 of the invention is applied;

FIGS. 4A to 4L are schematic diagrams each illustrating post-processing performed by a post-processing portion of an image forming apparatus to which an image forming program according to Exemplary Embodiment 1 of the invention is applied;

FIG. 5 is a block diagram illustrating a control device of the image forming apparatus to which the image forming program according to Exemplary Embodiment 1 of the invention is applied;

FIG. 6 is a plan configuration view illustrating a recording paper sheet on which a test image is formed;

FIGS. 7A to 7D are descriptive diagrams illustrating the test image in an enlarged manner;

FIG. 8 is a descriptive diagram illustrating arrangement of recording paper sheets on which an image is formed by the image forming apparatus to which the image forming program according to Exemplary Embodiment 1 of the invention is applied;

FIGS. 9A to 9F are descriptive diagrams each illustrating misregistration and size deviation of the image;

FIGS. 10A and 10B are descriptive diagrams each illustrating the misregistration of the image;

FIG. 11 is a table illustrating an amount of the misregistration of the image;

FIG. 12 is a graph illustrating the amount of the misregistration of the image;

FIG. 13 is a flowchart illustrating an operation of the image forming apparatus to which the image forming program according to Exemplary Embodiment 1 of the invention is applied;

FIG. 14 is a flowchart illustrating the operation of the image forming apparatus to which the image forming program according to Exemplary Embodiment 1 of the invention is applied;

FIG. 15 is a flowchart illustrating an operation of an image forming apparatus to which an image forming program according to a modification example of Exemplary Embodiment 1 of the invention is applied;

FIGS. 16A and 16B are tables illustrating the amount of the misregistration of the image;

FIG. 17 is a schematic diagram illustrating an image forming apparatus to which an image forming program according to Exemplary Embodiment 2 of the invention is applied;

FIG. 18 is a block diagram illustrating a control device of the image forming apparatus to which the image forming program according to Exemplary Embodiment 2 of the invention is applied;

FIG. 19 is a flowchart illustrating an operation of the image forming apparatus to which the image forming program according to Exemplary Embodiment 2 of the invention is applied;

FIGS. 20A and 20B are tables illustrating a temperature-correction amount lookup table;

FIG. 21 is a flowchart illustrating an operation of an image forming apparatus to which an image forming program according to a modification example of Exemplary Embodiment 2 of the invention is applied;

FIG. 22 is a graph illustrating a relationship between time and an inside temperature in the image forming portion of the image forming apparatus; and

FIGS. 23A and 23B are diagrams illustrating the temperature-correction amount lookup table.

### DETAILED DESCRIPTION

Hereinafter, exemplary embodiments of the invention will be described with reference to the drawings.

### Exemplary Embodiment 1

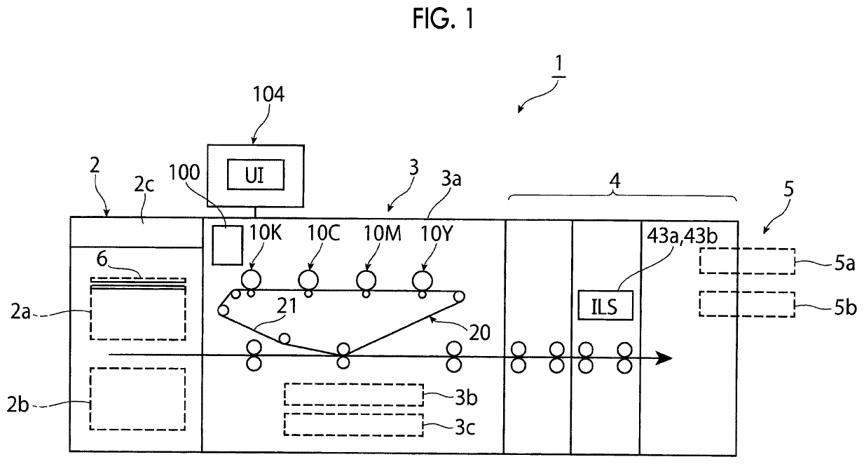

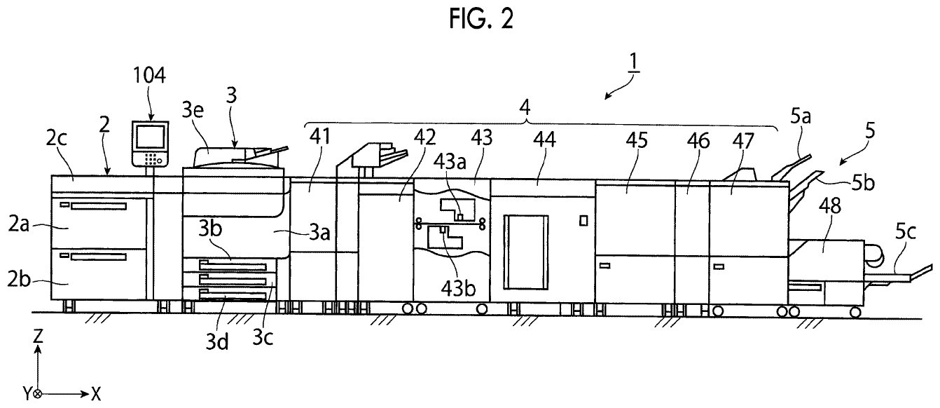

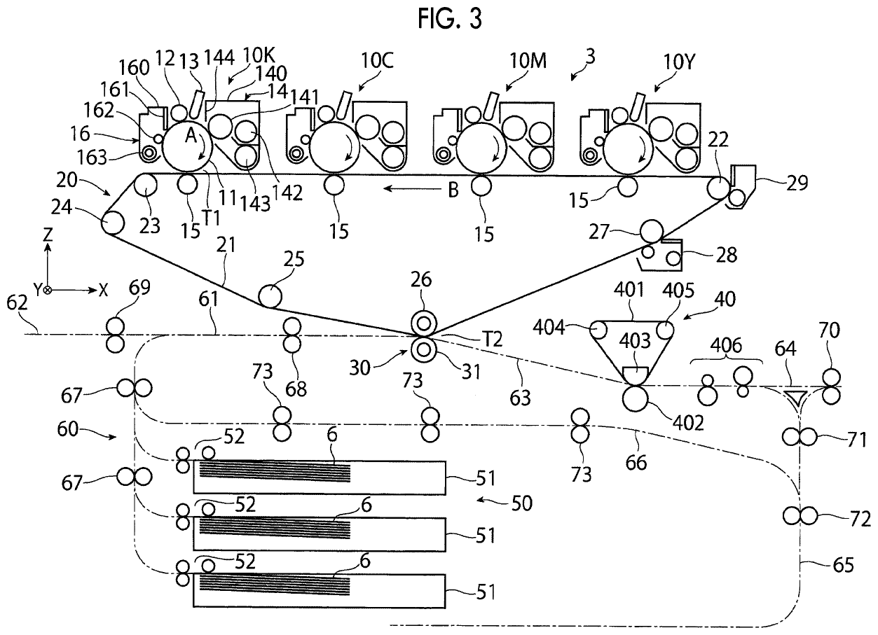

FIG. 1 is a schematic diagram illustrating an overall configuration of an image forming apparatus to which an image forming program and an image forming system according to Exemplary Embodiment 1 are applied. FIG. 2 is a schematic diagram illustrating the overall configuration of the image forming apparatus to which the image forming program and the image forming system according to Exemplary Embodiment 1 are applied. FIG. 3 is a configuration diagram illustrating an image forming portion of the image forming apparatus to which the image forming program and the image forming system according to Exemplary Embodiment 1 are applied. In FIG. 2, arrow X indicates a horizontal direction of the image forming apparatus, arrow Y indicates a depth direction of the image forming apparatus, and arrow Z indicates a vertical direction of the image forming apparatus.

### Overall Configuration of Image Forming Apparatus

An image forming apparatus 1 is configured as, for example, a full color production printer. As illustrated in FIG. 1, the image forming apparatus 1 broadly includes a paper feed portion 2, an image forming portion 3, a post-processing portion 4, and a discharge portion 5. The image forming apparatus 1 does not necessarily include all of the paper feed portion 2, the post-processing portion 4, the discharge portion 5, and the like. For example, the image forming apparatus 1 may not include the post-processing portion 4, and the paper feed portion 2, the image forming portion 3, and the like may be disposed in an apparatus body 3a constituting the image forming portion 3.

The paper feed portion 2 of the image forming apparatus 1 is configured with, for example, two high capacity trays 2a and 2b that include an air suction mechanism, a multifeed detection device, and the like and that are disposed above and below each other, and a manual paper feed tray 2c disposed above the high capacity tray 2a. The paper feed portion 2 is not limited to the feed portion including the air suction mechanism, the multifeed detection device, and the like.

The image forming portion 3 of the image forming apparatus 1 forms an image such as a full color or monochrome image on one side or two sides of a recording paper sheet 6 as an example of a recording medium supplied from the paper feed portion 2. The image forming apparatus 1 according to Exemplary Embodiment 1 includes a single or a plurality of paper feed trays 3b, 3c, . . . in the image forming portion 3.

The post-processing portion 4 performs required post-processing such as bending correction processing, inspection (reading) processing of the image, stack processing, binding processing, folding processing, and perforation processing on the recording paper sheet 6 on which the image is formed on one side or two sides by the image forming portion 3.

The discharge portion 5 discharges the recording paper sheet 6 on which the required post-processing is performed by the post-processing portion 4 to a single or a plurality of discharge trays 5a, 5b, . . . . A fixed tray, a stack tray, a booklet tray, or the like is used as the discharge trays 5a, 5b, . . . . The fixed tray is fixedly disposed. The stack tray discharges the recording paper sheet 6 by moving along a top-to-bottom direction that is the vertical direction Z, or a front-to-rear direction that is the depth direction Y, as necessary. The booklet tray discharges a booklet consisting of a plurality of recording paper sheets 6 on which the binding processing is performed, by moving along the horizontal direction.

To further describe the configuration of the image forming apparatus 1 as the production printer, as illustrated in FIG. 2, the image forming apparatus 1 includes the paper feed portion 2 on an upstream side (in the drawing, a left side) along a transport direction of the recording paper sheet 6 with reference to the image forming portion 3. The image forming apparatus 1 includes the post-processing portion 4 and the discharge portion 5 on a downstream side (in the drawing, a right side) along the transport direction of the recording paper sheet 6 of the image forming portion 3. The post-processing portion 4 is configured with, for example, a bending correction device 41, a paper sheet insertion device 42, an image inspection device 43, a high capacity stacker 44, a head and tail cutting device 45, a folding device 46, a binding device 47 having a punch and discharge function, and a fore edge cutting device 48 having a square back folding function. The discharge portion 5 is configured with the fixed tray 5a and the stack tray 5b as a discharge tray mounted in the binding device 47, and a booklet tray 5c mounted in the fore edge cutting device 48.

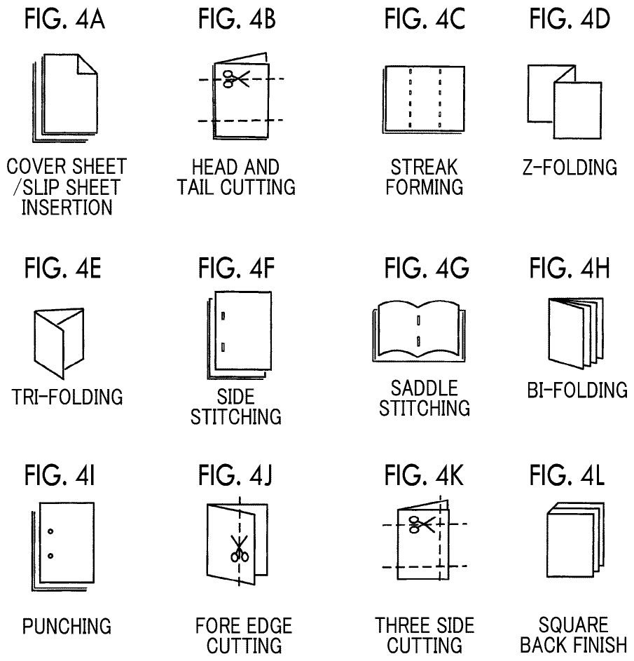

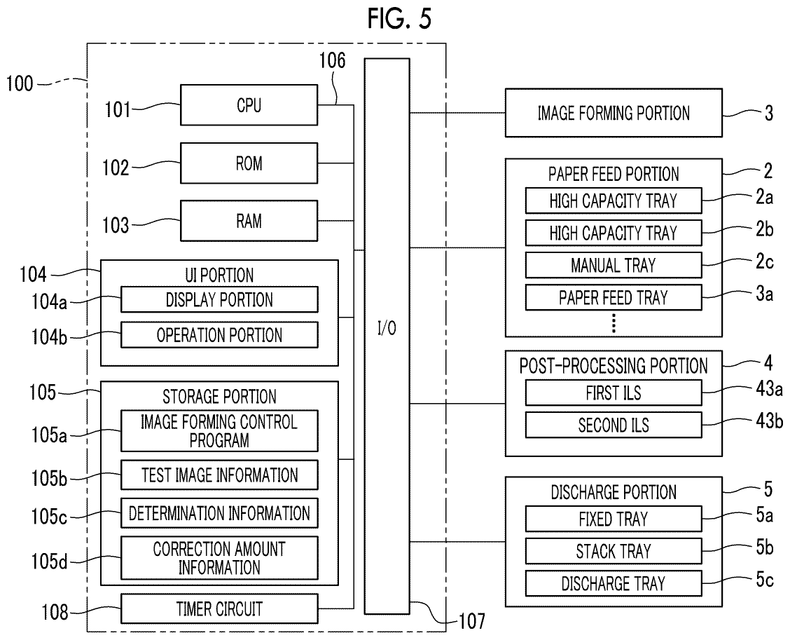

The bending correction device 41 corrects bending of the recording paper sheet 6 discharged from the image forming portion 3. The paper sheet insertion device 42, as illustrated in FIG. 4A, inserts a cover sheet, a slip sheet, or the like at a predetermined position in a plurality of recording paper sheets 6 continuously discharged from the image forming portion 3. The image inspection device 43 inspects a printed matter by reading the image including a test image formed on a front side and a rear side of the recording paper sheet 6 via first and second in line sensors (ILSs) 43a and 43b as an example of a reading unit (an image sensor). The first and second ILSs 43a and 43b can read the image with a predetermined resolution and color (brightness, chroma, and hue). The high capacity stacker 44 connects the image inspection device 43 to the head and tail cutting device 45 on the subsequent stage and adjusts a processing speed by sequentially stacking a large number of recording paper sheets 6. The head and tail cutting device 45, as illustrated in FIG. 4B, cuts an upper side and a lower side (a head and a tail) of the recording paper sheet 6 over a required width. The head and tail cutting device 45, as illustrated in FIG. 4C, also executes, for example, processing of forming streaks on the recording paper sheet 6. The folding device 46, as illustrated in FIGS. 4D and 4E, performs the folding processing such as Z-folding or tri-folding on the recording paper sheet 6. The binding device 47 sorts and stacks the recording paper sheet 6 after passing through the folding device 46 and, as illustrated in FIGS. 4F to 4I, performs bi-folding or perforation processing in addition to the binding processing such as side stitching or saddle stitching. The recording paper sheet 6 on which the binding processing such as edge stitching or saddle stitching, perforation processing, or the like is performed is discharged to the fixed tray 5a or the stack tray 5b of the discharge portion 5 in accordance with content or the like of the post-processing. The fore edge cutting device 48, as illustrated in FIGS. 4J to 4L, performs fore edge cutting processing and three side cutting processing of cutting upper and lower edges and another one edge of the recording paper sheet 6 on which the saddle stitching processing or the like is performed, and further performs square back finish processing or the like. The recording paper sheet 6 on which the fore edge cutting processing or the like is performed is sequentially discharged to the booklet tray 5c disposed in the horizontal direction.

Next, a configuration of the image forming portion 3 of the image forming apparatus 1 will be described.

As illustrated in FIG. 3, the image forming portion 3 of the image forming apparatus 1 broadly includes a plurality of image creating devices 10, an intermediate transfer device 20, a paper feed device 50, a paper sheet transport device 60, a fixing device 40, and the like. In the illustrated exemplary embodiment, the image forming portion 3, as illustrated in FIG. 2, includes an image reading device 3e that reads an image of an original document, at an upper end of the image forming portion 3.

The plurality of image creating devices 10, as illustrated in FIG. 3, form a toner image (a color material image) developed with toner as an example of a color material constituting a developer. The intermediate transfer device 20 holds and transports each toner image formed by each image creating device 10 to a secondary transfer position T2 at which the toner image is finally transferred to the recording paper sheet 6. The paper feed device 50 accommodates and supplies the required recording paper sheet 6 to be transported to the secondary transfer position T2 of the intermediate transfer device 20. The paper sheet transport device 60 transports the recording paper sheet 6 through the secondary transfer position T2 of the intermediate transfer device 20. The fixing device 40 fixes the toner image secondarily transferred by the intermediate transfer device 20 on the recording paper sheet 6.

The plurality of image creating devices 10 and the intermediate transfer device 20 are examples of an image forming unit that forms an image on the recording paper sheet 6 under a predetermined condition. Here, the predetermined condition indicates that an image is formed with a predetermined size at a predetermined position of the recording paper sheet 6 and misregistration or size deviation of the image falls within an allowable range, and an image is formed on the recording paper sheet 6 with predetermined density (including tone) and density deviation falls within an allowable range. In a case where the image formed on the recording paper sheet 6 is a text image or a line image, the predetermined condition only indicates that the image is formed with the predetermined size at the predetermined position of the recording paper sheet 6 and the misregistration or the size deviation falls within the allowable range.

The image creating devices 10 are configured with four image creating devices 10Y, 10M, 10C, and 10K that are dedicated to forming toner images of four colors including yellow (Y), magenta (M), cyan (C), and black (K), respectively. The four image creating devices 10 (Y, M, C, and K) are disposed at required intervals along a periphery of an intermediate transfer belt 21 in an internal space of the apparatus body 3a (see FIG. 1) of the image forming portion 3.

Each image creating device 10 (Y, M, C, and K), as illustrated in FIG. 3, includes a photoreceptor drum 11 that is an example of an image holding unit that rotates. A toner image forming unit described below is generally disposed on a periphery of the photoreceptor drum 11. The toner image forming unit includes a charging device 12, an exposure device 13, a developing device 14, a primary transfer device 15, a drum cleaning device 16, and the like. The charging device 12 charges a peripheral surface (an image holding surface) of the photoreceptor drum 11 on which an image can be formed, to a required potential. The exposure device 13 forms electrostatic latent images with a difference in potential (for each color) by irradiating the charged peripheral surface of the photoreceptor drum 11 with light based on information (a signal) about the image. The developing device 14 forms the toner images by developing the electrostatic latent images with the toner of the developer of corresponding colors (Y, M, C, and K). The primary transfer device 15 transfers each toner image to the intermediate transfer device 20. The drum cleaning device 16 performs cleaning by removing an adhering substance such as the toner that remains adhering to the image holding surface of the photoreceptor drum 11 after primary transfer.

The photoreceptor drum 11 is obtained by forming the image holding surface including a photoconductive layer (a photoreceptive layer) consisting of a photoreceptive material on a peripheral surface of a cylindrical or columnar base material that is processed to be grounded. The photoreceptor drum 11 is supported to rotate in a direction indicated by arrow A by transmitting driving force from a driving device (not illustrated) to the photoreceptor drum 11.

The charging device 12 is configured with a contact type charging roll disposed in a state of being in contact with the photoreceptor drum 11. The charging device 12 is supplied with a charging voltage. In a case where the developing device 14 performs reversal developing, a voltage or a current having the same polarity as a charging polarity of the toner supplied from the developing device 14 is supplied as the charging voltage. A non-contact type charging device such as a scorotron disposed in a non-contact state with the photoreceptor drum 11 may also be used as the charging device 12.

The exposure device 13 consists of an LED printhead that forms the electrostatic latent image configured in accordance with the information on the image input into the image forming apparatus 1 by irradiating the photoreceptor drum 11 with light via LEDs as a plurality of light emitting elements arranged along an axial direction of the photoreceptor drum 11. When the latent image is formed, the information (the signal) on the image input into the image forming apparatus 1 by any unit is transmitted to the exposure device 13. An exposure device that forms the electrostatic latent images by irradiating the peripheral surface of the charged photoreceptor drum 11 with laser light configured in accordance with the information on the image input into the image forming apparatus 1 may be used as the exposure device 13.

Each developing device 14 is configured by disposing a developing roll 141, agitating and transport members 142 and 143, a layer thickness regulating member 144, and the like in a housing 140 in which an opening portion and an accommodating chamber for the developer are formed. The developing roll 141 holds the developer in the housing 140 and transports the developer to a developing region facing the photoreceptor drum 11. The agitating and transport members 142 and 143 consist of a screw auger or the like that transports the developer through the developing roll 141 while agitating the developer. The layer thickness regulating member 144 regulates an amount (a layer thickness) of the developer to be held on the developing roll 141. The developing device 14 is supplied with a developing bias voltage from a power supply device (not illustrated) between the developing roll 141 and the photoreceptor drum 11. The developing roll 141 and the agitating and transport members 142 and 143 rotate in a required direction by transmitting driving force from a driving device (not illustrated) to the developing roll 141 and the agitating and transport members 142 and 143. Two-component developers including non-magnetic toner and a magnetic carrier are used as the above developers of four colors (Y, M, C, and K). The developing device 14 is supplied with toner of corresponding colors from a toner cartridge (not illustrated) at a required timing, and toner density in the housing 140 is adjusted.

The primary transfer device 15 is a contact type transfer device including a primary transfer roll that comes into contact with the peripheral surface of the photoreceptor drum 11 and rotates at a primary transfer position T1 with the intermediate transfer belt 21 interposed between the primary transfer device 15 and the photoreceptor drum 11 and that is supplied with a primary transfer voltage. A direct current voltage having a polarity opposite to the charging polarity of the toner is supplied from a power supply device (not illustrated) as the primary transfer voltage.

The drum cleaning device 16 is configured with a cleaning blade 161 and a cleaning brush 162 disposed in a body 160 having a container shape, a feed member 163, and the like. The cleaning blade 161 and the cleaning brush 162 perform cleaning by removing the adhering substance on the photoreceptor drum 11. The feed member 163 collects the adhering substance such as the toner removed by the cleaning blade 161 and the cleaning brush 162 and transports the adhering substance to be fed to a collection system (not illustrated).

The intermediate transfer device 20, as illustrated in FIG. 3, is disposed to be present below the image creating devices 10 (Y, M, C, and K) along the vertical direction Z. The intermediate transfer device 20 is generally configured with the intermediate transfer belt 21, a plurality of belt support rolls 22 to 27, a secondary transfer device 30, and two belt cleaning devices 28 and 29. The intermediate transfer belt 21 is an example of an intermediate transfer medium that circulates in a direction indicated by arrow B while passing through the primary transfer position T1 between the photoreceptor drum 11 and the primary transfer device 15 (the primary transfer roll). The plurality of belt support rolls 22 to 27 support the intermediate transfer belt 21 such that the intermediate transfer belt 21 is held in a favorable state from an inner periphery of the intermediate transfer belt 21 and can move in circulation. The secondary transfer device 30 is disposed on an outer peripheral surface (the image holding surface) side of the intermediate transfer belt 21 supported by the belt support roll 26 and secondarily transfers the toner image on the intermediate transfer belt 21 to the recording paper sheet 6. The belt cleaning devices 28 and 29 perform cleaning by removing the adhering substance such as the toner, paper dust, or the like that remains adhering to the outer peripheral surface of the intermediate transfer belt 21 after passing through the secondary transfer device 30.

For example, an endless belt made of a material obtained by dispersing a resistance adjusting agent such as carbon black in a synthetic resin such as a polyimide resin or a polyamide resin is used as the intermediate transfer belt 21. The belt support roll 22 is configured as a driving roll and also as a support roll of the belt cleaning device 29. The belt support roll 23 is configured as a leveling roll that holds a traveling position of the intermediate transfer belt 21. The belt support roll 24 is configured as a tension applying roll that applies tension to the intermediate transfer belt 21. The belt support roll 25 is configured as a driven roll that holds the traveling position of the intermediate transfer belt 21. The belt support roll 26 is configured as a backup roll of the secondary transfer device 30. The belt support roll 27 is configured as a support roll of the belt cleaning device 28.

The secondary transfer device 30, as illustrated in FIG. 3, includes a secondary transfer roll 31 that rotates at the secondary transfer position T2 that is an outer peripheral surface part of the intermediate transfer belt 21 supported by the belt support roll 26 in the intermediate transfer device 20. The secondary transfer roll 31 or the belt support roll 26 of the intermediate transfer device 20 is supplied with a direct current voltage having the opposite polarity or the same polarity as the charging polarity of the toner as a secondary transfer voltage.

The fixing device 40 is configured by disposing a heating rotor 401 in a belt form or a roll form and a pressing rotor 402 in a roll form or a belt form that is driven to rotate in contact with the heating rotor 401 at a predetermined pressure in a state of being substantially parallel to an axial direction of the heating rotor 401, in a housing (not illustrated) in which an introduction port and an discharge port of the recording paper sheet 6 are formed. The heating rotor 401 in the belt form is rotatably stretched between a heating member 403 in a pad form or a roll form and stretching rolls 404 and 405 also serving as heating units. In the fixing device 40, a contact portion in which the heating rotor 401 and the pressing rotor 402 are in contact with each other is a fixing processing portion that performs required fixing processing (heating and pressing).

A cooling device (not illustrated) that cools the recording paper sheet 6, a bending correction device 406, and the like may be disposed on a downstream side of the fixing device 40.

The paper feed device 50, as illustrated in FIG. 3, is disposed to be present at a position below the intermediate transfer device 20 in the vertical direction Z. The paper feed device 50 is generally configured with a paper sheet accommodator 51 constituting the plurality of (or single) paper feed trays 3b, 3c, and 3d, and a feed device 52. The paper sheet accommodator 51 accommodates the recording paper sheet 6 having a required size, material, and the like in a state where the recording paper sheet 6 is stacked. The feed device 52 feeds the recording paper sheet 6 one sheet at a time from the paper sheet accommodator 51. The paper feed trays 3b, 3c, and 3d consisting of the paper sheet accommodator 51, as illustrated in FIG. 2, are attached such that the paper feed trays 3b, 3c, and 3d can be pulled out to, for example, a front surface (a side surface that a user faces when performing an operation) side of the apparatus body 3a.

Examples of the recording paper sheet 6 include plain paper used in a copy machine or a printer of an electrophotographic system, thin paper such as tracing paper, and an OHP sheet consisting of a transparent film-shaped medium made of a synthetic resin (PET or the like). In order to further improve smoothness of an image surface after fixing, for example, the front side of the recording paper sheet 6 is as smooth as possible. For example, coated paper obtained by coating a front side of the plain paper with a rein or the like, or so-called thick paper having a relatively large paper weight, such as art paper for printing, can be appropriately used.

While the recording paper sheet 6 may have any size, not only a regular size such as A4 size (210×297 mm) or A3 size (297×420 mm) but also A4 extended size or A3 extended size slightly larger than A4 size or A3 size are used.

The paper sheet transport device 60 broadly includes a first paper feed transport path 61, a second paper feed transport path 62, an intermediate transport path 63, a discharge transport path 64, a reversal transport path 65, a two-sided transport path 66, and the like. The first paper feed transport path 61 is configured with a plurality of (or single) paper sheet transport roll pairs 67 and 68 that transport the recording paper sheet 6 fed from the paper sheet accommodator 51 of the paper feed device 50 to the secondary transfer position T2 of the intermediate transfer device 20, and a transport guide (not illustrated). The second paper feed transport path 62 is configured with a single (or a plurality of) paper sheet transport roll pair 69 that transports the recording paper sheet 6 supplied from the external paper feed portion 2 to join the first paper feed transport path 61, and a transport guide (not illustrated). The intermediate transport path 63 is configured with a transport belt (not illustrated) and the like that transport the recording paper sheet 6 on which the toner image is transferred at the secondary transfer position T2 of the intermediate transfer device 20, to the fixing device 40. The discharge transport path 64 is configured with a single (or a plurality of) discharge roll pair 70 that discharges the recording paper sheet 6 on which the toner image is fixed by the fixing device 40, to the outside of the image forming portion 3, and a transport guide (not illustrated). The reversal transport path 65 is configured with a transport roll pair 71 that transports the recording paper sheet 6 on which the image is formed on one side by switching the transport direction of the recording paper sheet 6 downward, a reversal roll pair 72 that reverses the front and the rear of the recording paper sheet 6, and a transport guide (not illustrated). The two-sided transport path 66 is configured with a plurality of (or single) paper sheet transport roll pairs 73 that transport the recording paper sheet 6 of which the front and the rear are reversed by the reversal transport path 65, to the first paper feed transport path 61 and that transport the recording paper sheet 6 again to the secondary transfer position T2 of the intermediate transfer device 20 via the first paper feed transport path 61, and a transport guide (not illustrated).

### Configuration of Control Device

As illustrated in FIG. 1, the image forming apparatus 1 includes a control device 100 configured with a computer and the like. As illustrated in FIG. 5, the control device 100 includes a central processing unit (CPU) 101 as an example of a processor, a read only memory (ROM) 102, a random access memory (RAM) 103, a user interface (UI) portion 104 as an example of a setting unit, a storage portion 105 as an example of a storage unit consisting of a non-volatile memory or the like, and a bus 106 that connects the CPU 101, the ROM 102, and the like, an input/output (I/O) interface 107, a timer circuit 108 as an example of a tracking unit that tracks time, and the like. The timer circuit 108 tracks various times including date and time information, such as an elapsed time from the end of a job executed by the image forming portion 3 to the start of the subsequent job in accordance with an instruction from the CPU 101.

The CPU 101 controls an operation of the whole image forming apparatus 1 in an integrated manner based on an image forming control program 105a as an example of the image forming program according to the present Exemplary Embodiment 1 stored in the storage portion 105. A part of or the whole image forming control program 105a may be stored in the ROM 102 or the like. In this case, the image forming control program 105a for executing only a part of the image forming control program 105a as a subroutine can be stored in the storage portion 105. The ROM 102 stores an image forming control program related to a basic image forming operation in the image forming control program 105a. The storage portion 105 stores test image information 105b, determination information 105c, correction amount information 105d, and the like. The test image information 105b is information about the test image formed on the recording paper sheet 6 by the image forming portion 3 of the image forming apparatus 1 at a predetermined timing. The determination information 105c is information including a plurality of predetermined threshold values for determining whether or not the test image formed on the recording paper sheet 6 is appropriate based on the test image information 105b.

The UI portion 104 includes a display portion 104a and an operation portion 104b for the user to operate the image forming apparatus 1. The display portion 104a and the operation portion 104b are configured with a liquid crystal display panel or the like having a touch panel function. The user selects and executes a required function from various functions of the image forming apparatus 1 displayed on the display portion 104a via the operation portion 104b.

The CPU 101 executes a print operation selected by the user via the UI portion 104, by controlling the image forming portion 3, the paper feed portion 2, the post-processing portion 4, and the discharge portion 5 of the image forming apparatus 1 via the input/output (I/O) interface 107 based on the image forming control program 105a.

In Exemplary Embodiment 1, the image forming control program 105a executed by the image forming apparatus 1 may be provided in a state where the image forming control program 105a is stored in a computer readable storage medium such as a magnetic storage medium (a magnetic tape, a magnetic disk (an HDD, a flexible disk (FD), or the like), or the like), an optical storage medium (an optical disk (a compact disk (CD), a digital versatile disk (DVD), or the like)), a magneto-optical storage medium, or a semiconductor memory (a flash ROM or the like). The image forming control program 105a may be downloaded via a network such as the Internet.

### Basic Operation of Image Forming Apparatus

Hereinafter, a basic image forming operation of the image forming apparatus 1 will be described.

The image forming apparatus 1 executes a print job of forming the image on the single or the plurality of recording paper sheets 6 in accordance with image information transmitted from a host computer or the like based on instruction information of a request for the image forming operation (print) selected by the user by operating the UI portion 104. The job is processing or a set of processing executed by the image forming apparatus 1 in order to execute the image forming operation.

Here, the image forming operation in forming a full color image configured with a combination of toner images of four colors (Y, M, C, and K) using the above four image creating devices 10 (Y, M, C, and K) will be described. The image forming operation in forming an image obtained by combining toner images of a single color or a plurality of colors using any one or more image creating devices 10 among the four image creating devices 10 (Y, M, C, and K) is basically the same.

In a case where the image forming portion 3 of the image forming apparatus 1 receives the instruction information of the request for the image forming operation (print) selected by the user by operating the UI portion 104, the four image creating devices 10 (Y, M, C, and K), the intermediate transfer device 20, the secondary transfer device 30, the fixing device 40, and the like start under control of the control device 100.

As illustrated in FIG. 3, in the image forming portion 3 of the image forming apparatus 1, first, each photoreceptor drum 11 rotates in the direction indicated by arrow A in each image creating device 10 (Y, M, C, and K). Each charging device 12 charges a front surface of each photoreceptor drum 11 to a required polarity (in Exemplary Embodiment 1, a negative polarity) and potential. Next, the exposure device 13 irradiates the charged front surface of the photoreceptor drum 11 with light emitted based on the signal of the image obtained by converting the information about the image input into the image forming apparatus 1 into each color component (Y, M, C, and K), and forms each electrostatic latent image of each color component configured with a required difference in potential on the front surface.

Here, the information about the image input into the image forming apparatus 1 is information about the image with which the user wants to form (print) the image on the recording paper sheet 6. In the image forming apparatus 1 according to Exemplary Embodiment 1, the information about the image includes the test image information 105b stored in the storage portion 105 of the control device 100 in addition to the information about the image with which the user wants to form (print) the image on the recording paper sheet 6.

Next, each developing device 14 performs developing by supplying the toner of the corresponding colors (Y, M, C, and K) charged to the required polarity (the negative polarity) to electrostatically adhere to the electrostatic latent images of each color component formed on the photoreceptor drum 11. Through such developing, the electrostatic latent images of each color component formed on each photoreceptor drum 11 are visualized as the toner images of four colors (Y, M, C, and K) developed with the toner of the corresponding colors, respectively.

Next, in a case where the toner images of each color formed on the photoreceptor drum 11 of each image creating device 10 (Y, M, C, and K) are transported to the primary transfer position T1, the primary transfer device 15 primarily transfers the toner images of each color to the intermediate transfer belt 21 rotating in the direction indicated by arrow B of the intermediate transfer device 20 in a state where the toner images are sequentially superimposed on each other.

In each image creating device 10 (Y, M, C, and K) after the end of the primary transfer, the drum cleaning device 16 cleans the front surface of the photoreceptor drum 11 by scraping to remove the adhering substance. Accordingly, each image creating device 10 (Y, M, C, and K) is in a state where a subsequent image creating operation can be performed.

Next, in the intermediate transfer device 20, as illustrated in FIG. 3, the primarily transferred toner images are held and transported to the secondary transfer position T2 through rotation of the intermediate transfer belt 21. Meanwhile, in the high capacity trays 2a and 2b provided in the paper feed portion 2 of the image forming apparatus 1, the required recording paper sheet 6 is fed to the second paper feed transport path 62 in accordance with the image creating operation. The recording paper sheet 6 fed from the high capacity trays 2a and 2b to the second paper feed transport path 62 is transported to the first paper feed transport path 61 of the image forming portion 3. In the first paper feed transport path 61, the paper sheet transport roll pair 68 as resist rolls supplies the recording paper sheet 6 to the secondary transfer position T2 by feeding the recording paper sheet 6 in accordance with a transfer timing. The recording paper sheet 6 on which the image is formed is not limited to the recording paper sheet 6 supplied from the high capacity trays 2a and 2b and may be the recording paper sheet 6 supplied from the paper feed device 50.

At the secondary transfer position, the secondary transfer roll 31 secondarily transfers the toner images on the intermediate transfer belt 21 to the recording paper sheet 6 at once. In the intermediate transfer device 20 after the end of the secondary transfer, the belt cleaning devices 28 and 29 perform cleaning by removing the adhering substance such as the toner remaining on the front surface of the intermediate transfer belt 21 after the secondary transfer.

Next, the recording paper sheet 6 on which the toner images are secondarily transferred is peeled off from the intermediate transfer belt 21 and the secondary transfer roll 31, and then transported to the fixing device 40 along the intermediate transport path 63. In the fixing device 40, the non-fixed toner images are fixed to the recording paper sheet 6 through necessary fixing processing (heating and pressing) by introducing the recording paper sheet 6 after the secondary transfer to pass through the fixing processing portion between the rotating heating rotor 401 and the rotating pressing rotor 402. Cooling processing or the bending correction processing is performed, as necessary, on the recording paper sheet 6 after the end of the fixing. Then, in a case where the image is formed on only one side of the recording paper sheet 6, the recording paper sheet 6 is discharged from the image forming portion 3 to the post-processing portion 4 by the discharge roll pair 70 via the discharge transport path 64.

In a case where the image is formed on two sides of the recording paper sheet 6, the recording paper sheet 6 on which the image is formed on one side is not discharged to the post-processing portion 4, and the transport direction of the recording paper sheet 6 is switched downward to the reversal transport path 65 along the vertical direction Z. The front and the rear of the recording paper sheet 6 transported to the reversal transport path 65 are reversed by the reversal roll pair 72, and then the recording paper sheet 6 is transported to the two-sided transport path 66. The recording paper sheet 6 of which the front and the rear are reversed is transported to the first paper feed transport path 61 again via the two-sided transport path 66, and the toner images are transferred to the rear side of the recording paper sheet 6 at the secondary transfer position T2 of the intermediate transfer device 20. In the recording paper sheet 6 on which the toner images are secondarily transferred, the non-fixed toner images are fixed by the fixing device 40, and the recording paper sheet 6 is discharged from the image forming portion 3 to the post-processing portion 4 by the discharge roll pair 70 via the discharge transport path 64.

Through the above operation, a full color image or the like formed by combining the toner images consisting of four colors (Y, M, C, and K) on one side or two sides of the recording paper sheet 6 is output.

As illustrated in FIG. 2, in the post-processing portion 4, the required post-processing such as the bending correction processing, the inspection (reading) processing of the image, the stack processing, the binding processing, the folding processing, and the perforation processing is performed on the recording paper sheet 6 on which the image is formed on one side or two sides by the image forming portion 3. The recording paper sheet 6 on which the post-processing is performed is discharged to the fixed tray 5a, the stack tray 5b, the booklet tray 5c, and the like of the discharge portion 5.

In the image forming apparatus 1 configured as described above, the image wanted by the user is printed on the designated recording paper sheet 6 in accordance with the print operation selected and designated by the user via the UI portion 104.

As illustrated in FIG. 3, the image forming portion 3 of the image forming apparatus 1 forms the toner images of each color in each image creating device 10 (Y, M, C, and K) of yellow (Y), magenta (M), cyan (C), and black (K). The toner images of each color formed by each image creating device 10 (Y, M, C, and K) are transferred to the recording paper sheet 6 in a superimposed manner on each other on the intermediate transfer belt 21 of the intermediate transfer device 20 and then fixed by the fixing device 40. Accordingly, an image such as a full color image is formed. Here, in the image forming portion 3 of the image forming apparatus 1, the misregistration, the size deviation, or the density deviation (including tone deviation) may occur in the images of each color of yellow (Y), magenta (M), cyan (C), and black (K) that are formed by each image creating device 10 (Y, M, C, and K) and that are superimposed on each other on the intermediate transfer belt 21 of the intermediate transfer device 20.

Then, in the image forming apparatus 1, the misregistration or the size deviation of the image or the density or tone deviation of the image occurs in the image finally formed on the single or the plurality of recording paper sheets 6 in the image forming portion 3, and the image wanted by the user (a target image) may not be printed.

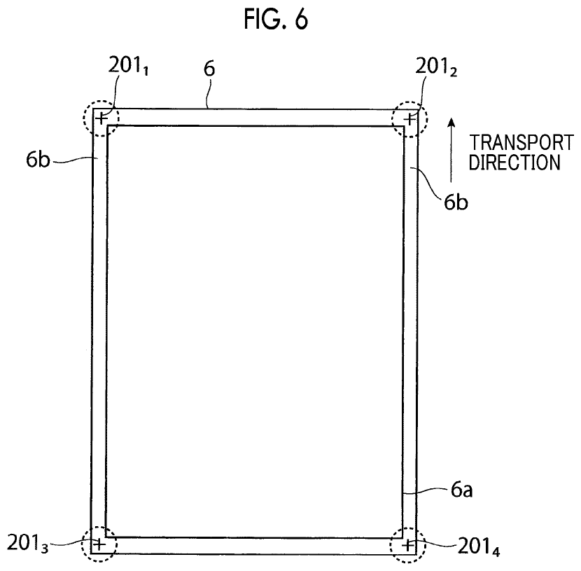

Therefore, in the image forming apparatus 1 according to Exemplary Embodiment 1, as illustrated in FIG. 6, the image forming portion 3 forms a misregistration detection pattern 201 at the same time on the recording paper sheet 6 of at least the first page in addition to the image wanted by the user. The misregistration detection pattern 201 is an example of the test image formed based on the test image information 105b. Here, while the misregistration and the size deviation of the image are described, the invention can also be applied to density deviation and tone deviation of the image.

The misregistration detection pattern 201 is an image for detecting the misregistration and the size deviation of the image. As illustrated in FIG. 2, in the image forming apparatus 1, the image inspection device 43 of the post-processing portion 4 reads the recording paper sheet 6 on which the misregistration detection pattern 201 is formed in the image forming portion 3. The control device 100 detects the misregistration or the size deviation of the image in accordance with a reading result of the image inspection device 43. The control device 100 calculates a misregistration correction amount for correcting the misregistration or the size deviation of the image. The control device 100 has a real time correction function of correcting a position of the image and a density of the image in the image forming portion 3 in real time in accordance with the misregistration correction amount of the image. Here, the real time correction is execution of an operation of correcting the position of the image and the density of the image during execution of one print job. A stop operation of temporarily stopping the print job, and the like may be included in the middle of one print job.

The CPU 101 of the control device 100 is an example of a correction unit that, in continuously forming the image on the plurality of recording paper sheets 6 in the image forming portion 3, obtains and corrects a correction amount for correcting an image forming condition in accordance with a reading result of an image of the misregistration detection pattern 201 formed on a specific number (n=an integer of 1 or more) of recording paper sheets 6 immediately after the start of forming of the image, based on the image forming control program 105a stored in the storage portion 105.

### Configuration of Test Image

As illustrated in FIG. 6, the test image is configured with the misregistration detection pattern 201. For example, the misregistration detection pattern 201 is formed in a region other than an original document area 6a in which the image wanted by the user is formed on the recording paper sheet 6. In the illustrated example, the region is a margin part 6b such as upper, lower, right, and left margins positioned on an outer periphery of the original document area 6a.

Here, the original document area 6a is a region having a required size including a standard size such as A4 size (210×297 mm) or A3 size (297×420 mm) for forming the image wanted by the user. In this case, for example, a paper sheet having A4 extended size or A3 extended size slightly larger than the standard size such as A4 size or A3 size is used as the recording paper sheet 6. A size of the recording paper sheet 6 is not limited to a size larger than the standard size and may also be the standard size such as A4 size or A3 size. In this case, the misregistration detection pattern 201 formed in the margin part 6b of the recording paper sheet 6 having the standard size is cut and removed in the post-processing portion 4.

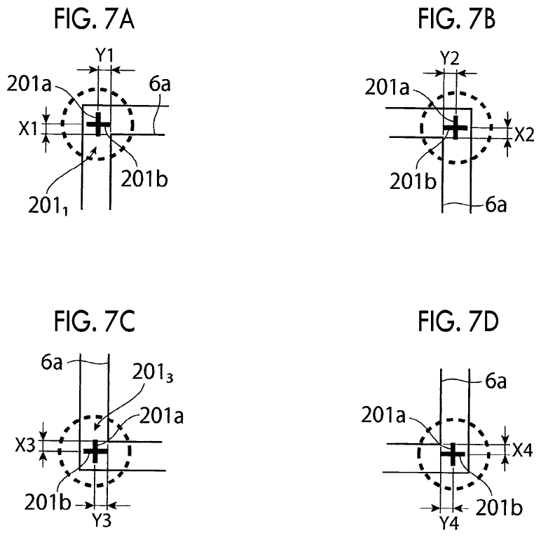

As illustrated in FIG. 6, for example, misregistration detection patterns 201₁ to 201₄ are respectively formed at four corners of the recording paper sheet 6, that is, four corner portions including an upper left portion and an upper right portion along a width direction intersecting with the transport direction of the recording paper sheet 6 and a lower left portion and a lower right portion along the transport direction of the recording paper sheet 6. The misregistration detection patterns 201₁ to 201₄ may have any colors. For example, the misregistration detection patterns 201₁ to 201₄ are formed in black (K). As illustrated in FIGS. 7A to 7D, for example, cross-shaped images consisting of a straight line image 201a along the transport direction of the recording paper sheet 6 and a straight line image 201b along a direction intersecting with the transport direction of the recording paper sheet 6 are used as the misregistration detection patterns 201₁ to 201₄. The straight line image 201a is formed at a position separated from the original document area 6a of the recording paper sheet 6 by predetermined distances (Y1, Y2, Y3, and Y4) along the width direction intersecting with the transport direction of the recording paper sheet 6. The straight line image 201b is formed at a position separated from the original document area 6a of the recording paper sheet 6 by predetermined distances (X1, X2, X3, and X4) along the transport direction of the recording paper sheet 6. For example, all of these distances (Y1, Y2, Y3, and Y4) and distances (X1, X2, X3, and X4) are set to equal values. The misregistration detection patterns 201₁ to 201₄ are not limited to four locations and may be provided at more than four locations, such as six locations or eight locations.

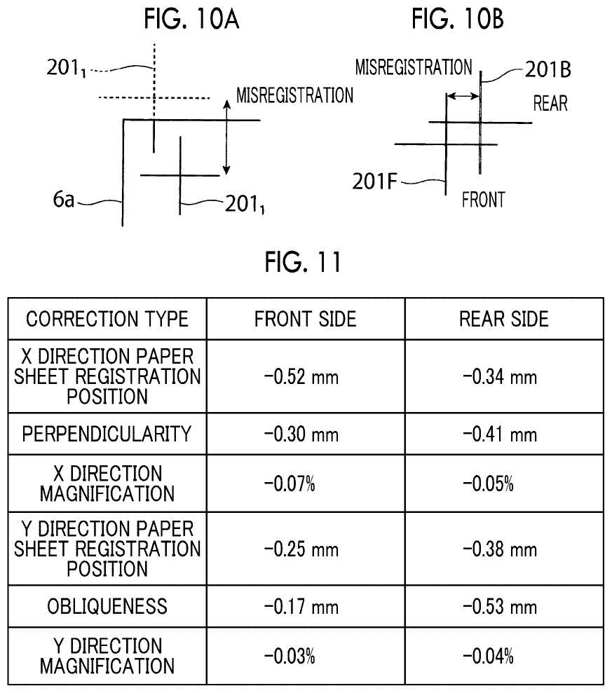

As illustrated in FIGS. 9A to 9F, the misregistration and the size deviation of the image can be classified into X direction misregistration, perpendicularity deviation, X direction magnification deviation, Y direction misregistration, obliqueness deviation, and Y direction magnification deviation. The X direction misregistration is, as illustrated in FIG. 9A, misregistration in which the image deviates parallel to the transport direction of the recording paper sheet 6. A deviation amount of the X direction misregistration is given as target value {(X2−X1)/2}. The perpendicularity deviation is, as illustrated in FIG. 9B, misregistration in which the image deviates in an inclined manner in a counterclockwise direction with respect to a right angle direction that is the transport direction of the recording paper sheet 6. A perpendicularity deviation amount is given as X2−X1. The X direction magnification deviation is, as illustrated in FIG. 9C, size deviation of the image in which a position at which the image is formed with respect to the recording paper sheet 6 is correct, but a magnification (a size) of the image deviates along the transport direction of the recording paper sheet 6. A deviation amount of the X direction magnification deviation is given as paper sheet size—{(X2−X1)/2}-{(X4−X3)/2}. The Y direction misregistration is, as illustrated in FIG. 9D, misregistration in which the image deviates parallel to the direction intersecting with the transport direction of the recording paper sheet 6. A deviation amount of the Y direction misregistration is given as target value—{(Y2−Y1)/2}. The obliqueness deviation is, as illustrated in FIG. 9E, misregistration in which the image deviates in an inclined manner with respect to the direction intersecting with the transport direction of the recording paper sheet 6. A deviation amount of the obliqueness deviation is given as Y2−Y1. The Y direction magnification deviation is, as illustrated in FIG. 9F, size deviation of the image in which a position at which the image is formed with respect to the recording paper sheet 6 is correct, but the magnification (the size) of the image deviates along the direction intersecting with the transport direction of the recording paper sheet. A deviation amount of the Y direction magnification deviation is given as paper sheet size—{(Y2−Y1)/2}-{(Y4−Y3)/2}. The misregistration and the size deviation occurring in the image formed on the recording paper sheet 6 consist of a combination of one or more of the X direction misregistration, the perpendicularity deviation, the X direction magnification deviation, the Y direction misregistration, the obliqueness deviation, and the Y direction magnification deviation. The misregistration of the image includes not only misregistration occurring on one side of the recording paper sheet 6 as illustrated in FIG. 10A but also misregistration occurring between the front side and the rear side of the recording paper sheet 6 as illustrated in FIG. 10B. The misregistration occurring between the front side and the rear side of the recording paper sheet 6 is separately detected as misregistration on the front side of the recording paper sheet 6 and misregistration on the rear side of the recording paper sheet 6 based on a misregistration detection pattern 201F formed on the front side of the recording paper sheet 6 and on a detection pattern 201B formed on the rear side of the recording paper sheet 6.

The control device 100 calculates whether or not the X direction misregistration, the perpendicularity deviation, the X direction magnification deviation, the Y direction misregistration, the obliqueness deviation, and the Y direction magnification deviation occur and the deviation amounts of the X direction misregistration, the perpendicularity deviation, the X direction magnification deviation, the Y direction misregistration, the obliqueness deviation, and the Y direction magnification deviation based on positional information (X1, Y1), (X2, Y2), (X3, Y3), and (X4, Y4) of the misregistration detection patterns 201₁ to 201₄ detected by the image inspection device 43 of the post-processing portion 4.

As illustrated in FIG. 11, for example, the calculated deviation amount of each of the X direction misregistration, the perpendicularity deviation, the X direction magnification deviation, the Y direction misregistration, the obliqueness deviation, and the Y direction magnification deviation is obtained as “−0.52 mm”, “−0.30 mm”, “−0.07%”, “−0.25 mm”, “−0.17 mm”, and “−0.03%” on the front side of the recording paper sheet 6.

In the same manner, as illustrated in FIG. 11, the calculated deviation amount of each of the X direction misregistration, the perpendicularity deviation, the X direction magnification deviation, the Y direction misregistration, the obliqueness deviation, and the Y direction magnification deviation is obtained as “−0.34 mm”, “−0.41 mm”, “−0.05%”, “−0.38 mm”, “−0.53 mm”, and “−0.04%” on the rear side of the recording paper sheet 6.

The control device 100 determines whether or not the calculated deviation amount of each of the X direction misregistration, the perpendicularity deviation, the X direction magnification deviation, the Y direction misregistration, the obliqueness deviation, and the Y direction magnification deviation falls within a range of a predetermined threshold value (an upper limit value and a lower limit value). The predetermined threshold value (the upper limit value and the lower limit value) of the deviation amount of each of the X direction misregistration, the perpendicularity deviation, the X direction magnification deviation, the Y direction misregistration, the obliqueness deviation, and the Y direction magnification deviation is stored in the storage portion 105 as the determination information 105c.

The control device 100 corrects the misregistration and the size deviation of the image in exposing the image to light on the photoreceptor drum 11 in the exposure device 13 of each image creating device 10 (Y, M, C, and K) of yellow (Y), magenta (M), cyan (C), and black (K) of the image forming portion 3. In exposing the image to light via the exposure device 13 of each image creating device 10 (Y, M, C, and K), the image forming portion 3 loads image data on a memory in page units based on the image information. The misregistration and the size deviation of the image are corrected by correcting a position at which the image data is loaded, in dot units or the like to correct the deviation amounts of the X direction misregistration, the perpendicularity deviation, the X direction magnification deviation, the Y direction misregistration, the obliqueness deviation, and the Y direction magnification deviation in loading the image data on the memory. Accordingly, in a case where the deviation amount of each of the X direction misregistration, the perpendicularity deviation, the X direction magnification deviation, the Y direction misregistration, the obliqueness deviation, and the Y direction magnification deviation illustrated in FIG. 11 exceeds the predetermined threshold value, the deviation amount indicates the correction amount of the image at the same time.

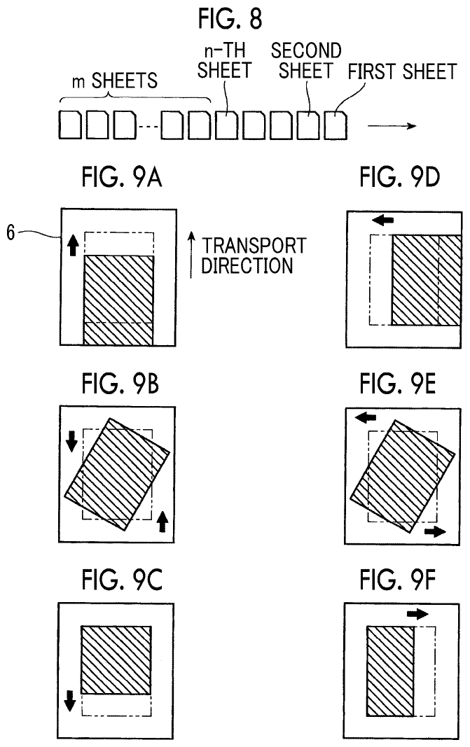

As illustrated in FIG. 8, the misregistration detection pattern 201 is basically formed on only the first recording paper sheet 6 immediately after the start of forming of the image among the plurality of recording paper sheets 6 on which the image is continuously formed. However, as the misregistration detection pattern 201, identical or different misregistration detection patterns 201 may be formed on a plurality of (n) recording paper sheets 6 immediately after the start of forming of the image among the plurality of recording paper sheets 6 on which the image is continuously formed. Here, n is an integer of 1 or more. In a case where the identical misregistration detection patterns 201 are formed on the plurality of (n) recording paper sheets 6, the deviation amount of each of the X direction misregistration, the perpendicularity deviation, the X direction magnification deviation, the Y direction misregistration, the obliqueness deviation, and the Y direction magnification deviation is obtained by calculating an average value. For example, the misregistration detection pattern 201 is not limited to the misregistration detection pattern 201 immediately after the start of the printing operation and is formed each time the image is printed on a predetermined number of recording paper sheets 6, each time a certain amount of time elapses from the start of the print operation, or when the print operation is finished.

In the image forming apparatus 1 of the related art, in a case where the print processing is executed, an inside temperature of the image forming portion 3 increases as time passes. Accordingly, a misregistration amount of the image changes over time.

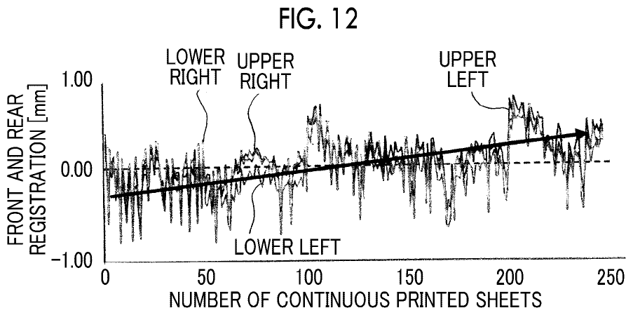

FIG. 12 is a graph illustrating differences between front and rear X direction misregistration read using the misregistration detection patterns 201₁ to 201₄ in a case where the image including the misregistration detection pattern 201 is continuously formed on both of the front and rear sides of the recording paper sheet 6 in the image forming portion 3 of the image forming apparatus 1 configured as illustrated in FIG. 3.

In FIG. 12, the differences between the front and rear deviation amounts obtained by each of the four misregistration detection patterns 201₁ to 201₄ formed in upper left, upper right, lower left, and lower right portions of the recording paper sheet 6 change to almost overlap with each other and show almost the same values. Accordingly, in a case where the print operation continues continuously on the plurality of recording paper sheets 6 in the image forming portion 3, a tendency of an increase in the differences between the front and rear deviation amounts of the X direction misregistration at a certain gradient in accordance with an increase in the number of continuous printed recording paper sheets 6 is understood.

In a case where the print operation continues continuously on the plurality of recording paper sheets 6 in the image forming portion 3 of the image forming apparatus 1, an inside temperature of the apparatus body 3a of the image forming portion 3 increases. Thus, the amount of the misregistration of the image formed by each image creating device 10 (Y, M, C, and K) of yellow (Y), magenta (M), cyan (C), and black (K) is considered to increase.

In the image forming apparatus 1 of the related art, in a case where the operation of continuously performing printing on the plurality of recording paper sheets 6 continues, the misregistration detection pattern 201 is formed at a predetermined timing such as the end of the print operation, and the deviation amount of each of the X direction misregistration, the perpendicularity deviation, the X direction magnification deviation, the Y direction misregistration, the obliqueness deviation, and the Y direction magnification deviation is calculated. The control device 100 is configured to obtain the correction amount in accordance with the calculated deviation amount of each of the X direction misregistration, the perpendicularity deviation, the X direction magnification deviation, the Y direction misregistration, the obliqueness deviation, and the Y direction magnification deviation and store and update the correction amount in a region of the correction amount information 105d in the storage portion 105 at any time, as illustrated in FIG. 5.

In the image forming apparatus 1 of the related art, in a case where a new job starts after the job of continuously performing printing on the plurality of recording paper sheets 6 is finished, the print operation is started by applying the latest correction amount information stored in the region of the correction amount information 105d in the storage portion 105, that is, the correction amount information acquired at the end of the previous job.

However, in the image forming portion 3 of the image forming apparatus 1, in a case where the user newly starts the job of continuously performing printing on the plurality of recording paper sheets 6, a certain amount of time generally elapses from the end of the previous job. Accordingly, the temperature inside the image forming portion 3 of the image forming apparatus 1 generally returns to a normal state (room temperature) because of a heat dissipation phenomenon during a resting time. In this state, in a case where the print operation is started by applying the latest correction amount stored in the region of the correction amount information 105d in the storage portion 105, the misregistration amount of the image in the image forming portion 3 is reduced as illustrated in an initial state in the left end portion of FIG. 12. However, in a case where the print operation is started by applying the latest correction amount stored in the region of the correction amount information 105d in the storage portion 105, the correction amount at the end of the previous job in the right end portion in FIG. 12 is applied. Accordingly, the image forming apparatus 1 of the related art poses a technical problem in that real time correction is not effectively applied immediately after the start of the subsequent job, and the misregistration of the image at the start of the print operation is more likely to be increased.

### Configuration of Characteristic Part of Image Forming Apparatus

Therefore, in the image forming apparatus according to Exemplary Embodiment 1, the storage unit is configured to store the correction amount obtained at the start of the job of the image forming unit and apply the correction amount at the start of the subsequent job.

That is, as illustrated in FIG. 5, the image forming apparatus 1 according to Exemplary Embodiment 1 includes, in the control device 100, the CPU 101 functioning as the correction unit that corrects the condition in accordance with the reading result of the image formed on the specific number of recording paper sheets 6 immediately after the start of forming of the image in continuously forming the image on the plurality of recording paper sheets 6, 6, . . . .

In a case where the print operation based on the real time correction is designated in the image forming apparatus 1, the CPU 101 functioning as the correction unit, as illustrated in FIG. 6, executes an operation of printing the image obtained by adding the misregistration detection pattern 201 as the test image to the image designated by the user on the specific number n of recording paper sheets 6 immediately after the start of forming of the image among the plurality of continuous recording paper sheets.

In a case where the print operation based on the real time correction is designated in the image forming apparatus 1, the CPU 101 executes the operation of printing the image obtained by adding the test image to the image designated by the user on the specific number n of recording paper sheets 6 immediately after the start of forming of the image among the plurality of continuous recording paper sheets 6.

Basically, the control device 100 includes the storage portion 105 as an example of the storage unit that stores the correction amount obtained at the start of the job of the image forming portion 3 among correction amounts obtained in accordance with the reading result of the misregistration detection pattern 201. The storage portion 105 stores the correction amount obtained at the start of the job of the image forming portion 3 as the correction amount information 105d.

### Operation of Characteristic Part of Image Forming Apparatus

In the image forming apparatus according to Exemplary Embodiment 1, the following is performed to enable correction appropriate for the recording medium immediately after the start of the subsequent job compared to a case where the correction amount obtained in finishing the job is stored and applied in starting the subsequent job.

That is, in the image forming apparatus 1 according to Exemplary Embodiment 1, in a case where the user executes a series of printing processing, as illustrated in FIG. 5, the user sets a print job that the user wants, such as the size and the material of the recording paper sheet 6 for forming the image, the number of printed sheets, or the content of the post-processing executed by the post-processing portion 4, by operating the operation portion 104b while viewing a screen displayed on the display portion 104a of the UI portion 104.

As illustrated in FIG. 6, the image forming apparatus 1 according to Exemplary Embodiment 1 forms the misregistration detection pattern 201 on the specific number of (n) recording paper sheets 6 immediately after the start of the job. Here, the CPU 101 reads the misregistration detection pattern 201 in the image inspection device 43, detects the deviation amount of the misregistration or the size deviation of the image in accordance with the reading result of the misregistration detection pattern 201, and calculates the correction amount of the misregistration or the size deviation of the image. The CPU 101 corrects the image to be formed on the recording paper sheet 6 in accordance with the obtained correction amount of the misregistration or the size deviation of the acquired image.

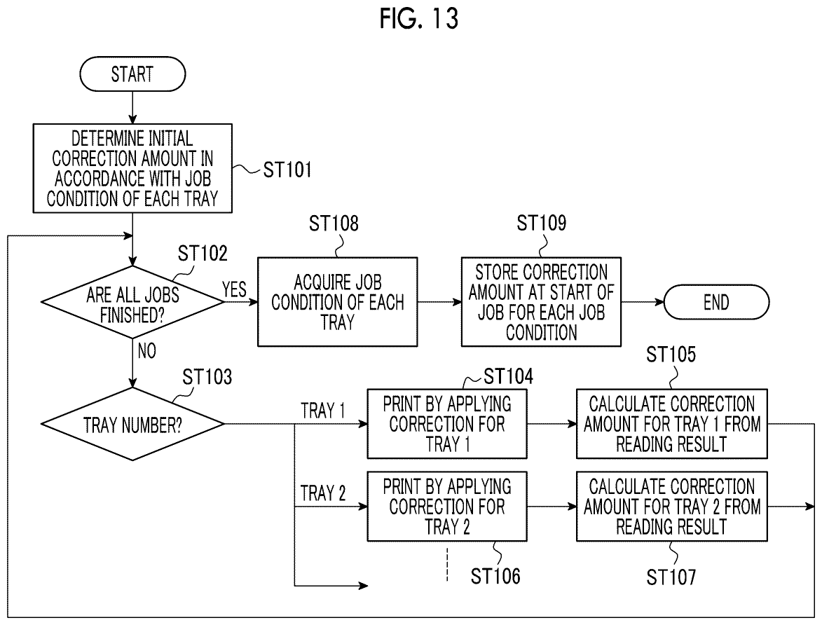

As illustrated in FIG. 13, the CPU 101 determines an initial correction amount in accordance with a job condition of each tray such as the high capacity trays 2a and 2b of the paper feed portion 2 and the paper feed trays 3a and 3b of the image forming portion 3 in accordance with content of the print job set using the operation portion 104b of the UI portion 104 (step S101).

Here, the initial correction amount corresponding to the job condition of each tray is the correction amount obtained at the start of the previous job in each tray of the image forming portion 3.

Next, the CPU 101 determines whether or not all jobs are finished (step S102). In a case where the CPU 101 determines that all jobs are not finished, the CPU 101 identifies a number of a tray designated by the job condition (step S103).

For example, in a case where the CPU 101 identifies that the number of the tray designated by the job condition is “1”, the CPU 101 executes the print operation by applying the correction amount stored for tray 1 among the correction amounts stored in the correction amount information 105d of the storage portion 105 (step S104). Then, the CPU 101 calculates the correction amount for tray 1 from the reading result of the misregistration detection pattern 201 (step S105), and returns to step S102.

In the same manner, the CPU 101 identifies the number of the tray designated by the job condition (step S103) until all jobs are finished (step S102), and executes the print operation by applying the correction amount for the identified tray among the correction amounts stored in the correction amount information 105d of the storage portion 105 (step S106). Then, the CPU 101 calculates the correction amount for tray 1 from the reading result of the misregistration detection pattern 201 (step S107).

In a case where the CPU 101 determines that all jobs are finished (step S102), the CPU 101 acquires the job condition of each tray set using the operation portion 104b of the UI portion 104 (step S108). Then, the correction amount at the start of the job is stored in the correction amount information 105d of the storage portion 105 for each job condition (step S109), and the processing is finished.

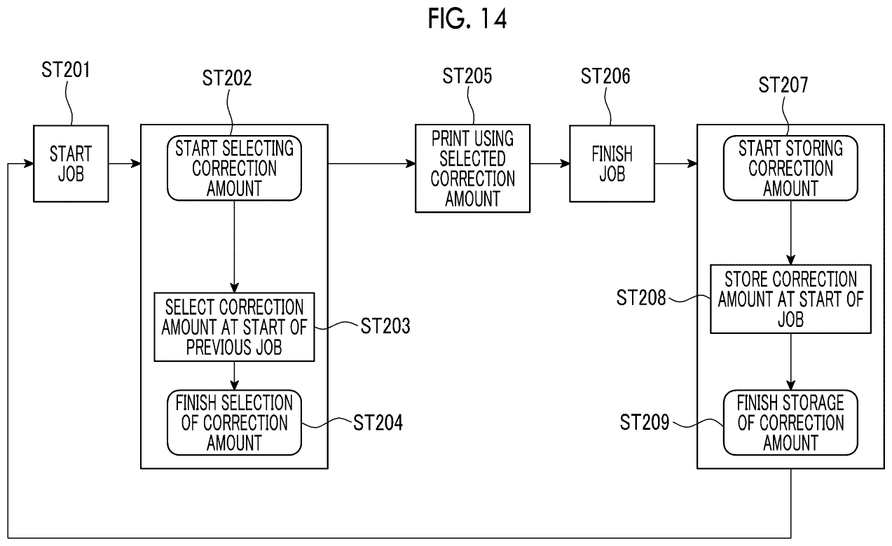

Next, as illustrated in FIG. 14, the CPU 101 starts a subsequent new job after the series of jobs are finished (step S201).

Then, the CPU 101 starts selection processing of the correction amount (step S202), selects the correction amount at the start of the previous job from the correction amounts stored in the correction amount information 105d of the storage portion 105 (step S203), and finishes the selection processing of the correction amount (step S204).

Then, the CPU 101 executes the print operation illustrated in FIG. 13 using the selected correction amount (step S205), and the job is finished (step S206). The CPU 101 starts storage processing of the correction amount (step S207), stores the correction amount at the start of the job in the storage portion 105 as the correction amount information 105d (step S208), and finishes the storage processing of the correction amount (step S209).

In the image forming apparatus 1 according to Exemplary Embodiment 1, in a case where a new job is started, the print operation is configured to be executed by applying the correction amount obtained at the start of the previous job.

Normally, a certain amount of time generally elapses from the end of the series of print jobs to the start of the subsequent job. Thus, by executing the print operation by applying the correction amount obtained at the start of the previous job, correction corresponding to the amount of the misregistration of the image at the start of the print operation can be performed, as illustrated in FIG. 12.

Accordingly, in the image forming apparatus 1 according to Exemplary Embodiment 1, correction appropriate for the recording paper sheet immediately after the start of the subsequent job may be performed compared to a case where the correction amount obtained in finishing the job is stored and applied in starting the subsequent job.

### Modification Example of Exemplary Embodiment 1

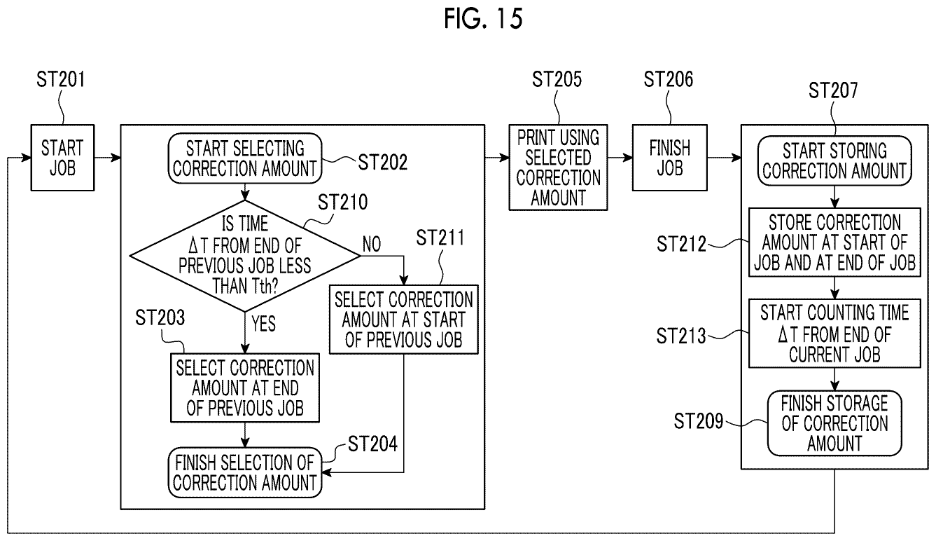

FIG. 15 is a flowchart illustrating an operation of an image forming apparatus according to a modification example of Exemplary Embodiment 1.

In the image forming apparatus 1 according to Exemplary Embodiment 1, the correction amount obtained at the start of the previous job is configured to be uniformly applied at the start of the subsequent job. Thus, the amount of time that elapses from the end of the previous job to the start of the subsequent job is not large, and a failure may occur in a case where the subsequent job is started soon after the previous job is finished.

That is, in the image forming apparatus 1, as illustrated in FIG. 12, in a case where the amount of time that elapses from the end of the previous job is not large, the inside temperature of the image forming portion 3 generally remains increased at a certain temperature, while the inside temperature also depends on the number of printed sheets in the previous job. Accordingly, in this case, for example, applying the correction amount at the end of the previous job at the start of the subsequent job is more effective than applying the correction amount at the start of the previous job in terms of correcting the misregistration and the size deviation of the image.

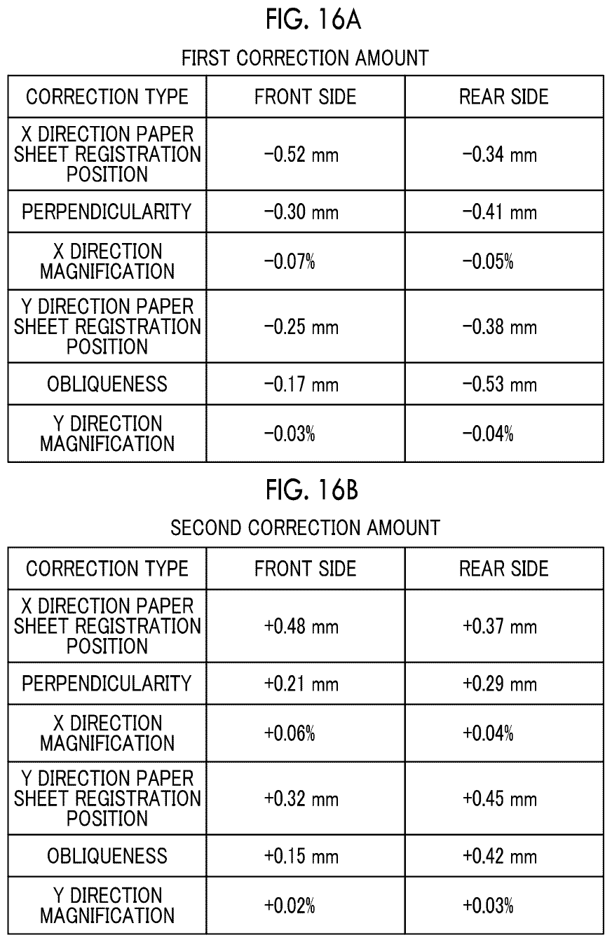

Therefore, as illustrated in FIG. 5, the image forming apparatus 1 according to the modification example of Exemplary Embodiment 1 includes the timer circuit 108 as an example of the tracking unit that tracks the elapsed time from the end of the job to the start of the subsequent job. As illustrated in FIGS. 16A and 16B, the correction amount information 105d of the storage portion 105 as an example of the storage unit is configured to store a first correction amount obtained at the start of the job and a second correction amount obtained after the start of the job. Any of the first correction amount or the second correction amount is configured to be applied as the correction amount stored in the correction amount information 105d of the storage portion 105 in accordance with the elapsed time tracked by the timer circuit 108. Here, the second correction amount is, for example, a correction amount obtained at the end of the job. The number of second correction amounts is not limited to one, and a plurality of second correction amounts may be set.

In the image forming apparatus 1 according to the modification example of Exemplary Embodiment 1, as illustrated in FIG. 15, in the selection processing of the correction amount (step S202) at the start of the job (step S201), the correction amount at the end of the previous job is not uniformly selected as in Exemplary Embodiment 1 (step S203), and whether or not a value of the elapsed time from the end of the previous job is less than a predetermined threshold time Tₜₕ is determined (step S210).

In a case where the CPU 101 determines that the value of the elapsed time from the end of the previous job is greater than or equal to the predetermined threshold value time Tₜₕ, the CPU 101 selects the correction amount at the start of the previous job as in Exemplary Embodiment 1 (step S211) and finishes the selection processing of the correction amount.

Meanwhile, in a case where the CPU 101 determines that the value of the elapsed time from the end of the previous job is less than the predetermined threshold value time Tₜₕ, the CPU 101 selects the correction amount at the end of the previous job instead of the correction amount at the start of the previous job (step S203) and finishes the selection processing of the correction amount.

Then, the CPU 101 executes the print operation using the selected correction amount (step S205) and finishes the job (step S206).

The CPU 101 starts the storage processing of the correction amount (step S207). In storing the correction amount, as illustrated in FIGS. 16A and 16B, the CPU 101 stores both of the correction amount at the start of the job and the correction amount at the end of the job in the storage portion 105 as the correction amount information 105d.

The CPU 101 starts counting the amount of time from the end of the current job (step S213) and finishes the storage processing of the correction amount (step S209).

In the image forming apparatus 1 according to the modification example of Exemplary Embodiment 1, by taking an elapsed time ΔT from the end of the previous job into consideration, the correction amount at the start of the previous job or at the end of the previous job can be applied at the start of the subsequent job instead of uniformly applying the correction amount at the start of the previous job. Thus, according to the image forming apparatus 1 according to the modification example of Exemplary Embodiment 1, the correction amount at the end of the previous job can be applied in a case where, for example, the amount of time elapsed from the end of the previous job is not large, and an image having small misregistration or size deviation can be formed by applying an optimal correction amount immediately after the start of the subsequent job.

### Exemplary Embodiment 2

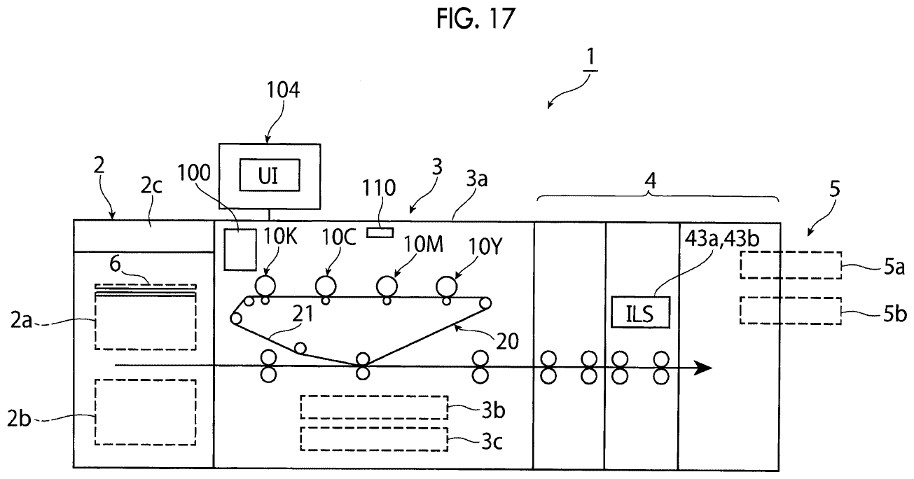

FIG. 17 is a schematic diagram illustrating an overall configuration of an image forming apparatus to which an image forming program and an image forming system according to Exemplary Embodiment 2 are applied.

The image forming apparatus according to Exemplary Embodiment 2 includes a detection unit that detects a temperature inside the image forming apparatus, in which the correction unit is configured to, in a case where a difference between a subsequent detection temperature of the detection unit at the start of the subsequent job and a previous detection temperature of the detection unit at the start of the previous job falls within a predetermined range, apply a correction value stored in the storage unit.

In the image forming apparatus according to Exemplary Embodiment 2, the storage unit further stores the correction amount obtained at the end of the job, and the correction unit is configured to apply a correction value close to a detection temperature of the detection unit at the start of the subsequent operation of forming the image among the correction amounts stored in the storage unit.

That is, as illustrated in FIG. 17, the image forming apparatus 1 according to Exemplary Embodiment 2 includes a temperature sensor 110 as an example of the detection unit that detects the temperature inside the apparatus body 3a of the image forming portion 3.

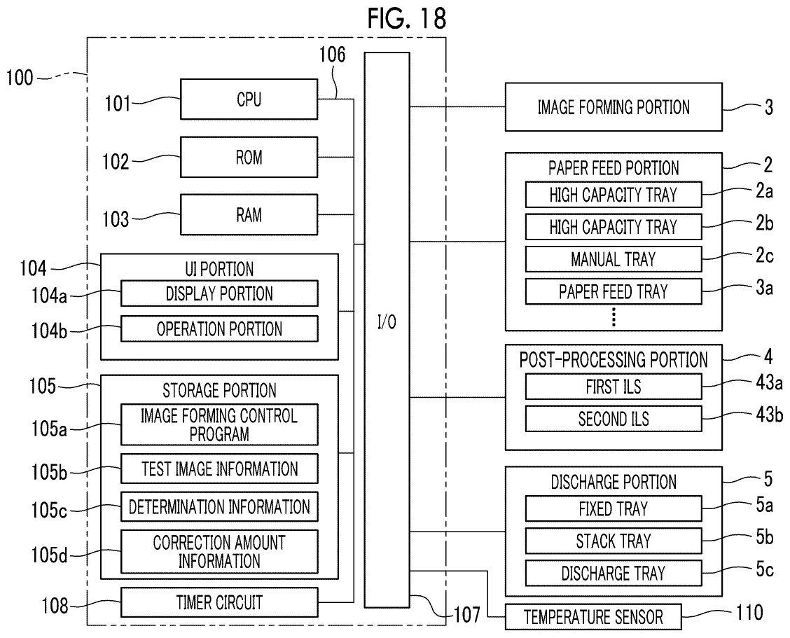

As illustrated in FIG. 18, the CPU 101 sequentially stores each elapse of a certain amount of time tracked by the timer circuit 108 from the start of the job of the image forming portion 3, and each correction amount obtained at the end of the job of the image forming portion 3 in the storage portion 105 as the correction amount information 105d.

Here, the storage portion 105 stores the correction amount obtained at the start of the job as the first correction amount and stores the correction amount obtained after the start of the job as the second correction amount.

The storage portion 105 is configured to apply any of the first correction amount or the second correction amount among the correction amounts stored as the correction amount information 105d in accordance with an instruction from the CPU 101. A plurality of second correction amounts may be present.

The CPU 101 is configured to apply the correction value stored in the storage unit in a case where the difference between the subsequent detection temperature of the temperature sensor at the start of the subsequent job and the previous detection temperature of the temperature sensor at the start of the previous job falls within the predetermined range.

### Operation of Exemplary Embodiment 2

In the image forming apparatus 1 according to Exemplary Embodiment 2 configured as described above, the following is performed to enable correction appropriate for the recording medium immediately after the start of the subsequent job compared to a case where the correction amount obtained in finishing the job is stored and applied in starting the subsequent job.

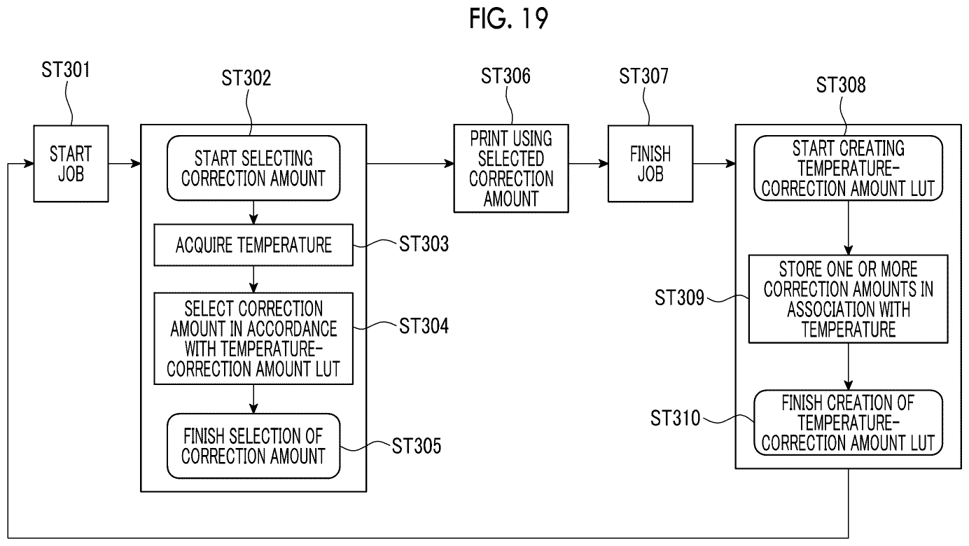

In the image forming apparatus 1 according to Exemplary Embodiment 2, as illustrated in FIG. 19, the CPU 101 starts a new job (step S301).

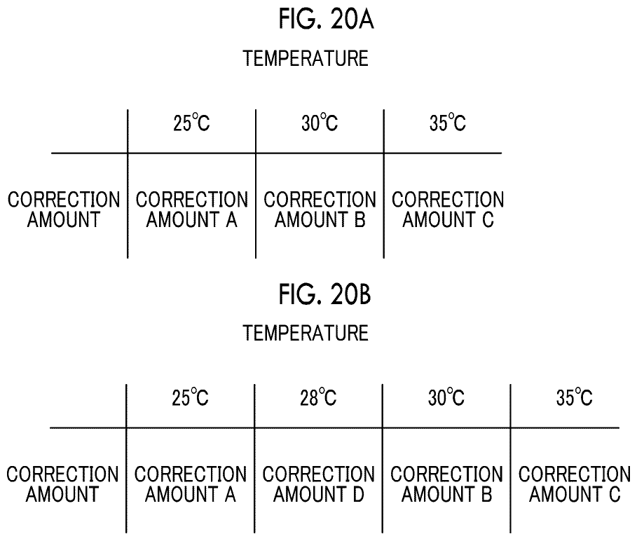

Then, the CPU 101 starts the selection processing of the correction amount (step S302) and acquires the temperature inside the image forming portion 3 detected by the temperature sensor 110 (step S303). The CPU 101, as illustrated in FIGS. 20A and 20B, selects the correction amount with reference to a temperature-correction amount lookup table (LUT) (step S304) and finishes the selection processing of the correction amount (step S305).

Then, the CPU 101 executes the print operation with the correction amount selected with reference to the temperature-correction amount lookup table (LUT) (step S306) and finishes the job (step S307).

The CPU 101 starts creating the temperature-correction amount lookup table (LUT) (step S308). The CPU 101 stores one or more correction amounts by associating the correction amount with the temperature (step S309) and finishes creation of the temperature-correction amount lookup table (LUT) (step S310).

Here, in a case where the temperature inside the image forming portion 3 detected by the temperature sensor 110 is, for example, 28° C., a correction amount B at 30° C. in the temperature-correction amount lookup table (LUT) illustrated in FIGS. 20A and 20B is applied.

Then, in a case where the print job to which the correction amount B at 30° C. is applied is finished, the CPU 101, as illustrated in FIG. 20B, updates and creates the temperature-correction amount lookup table (LUT) by associating a new correction amount D obtained using the misregistration detection pattern 201 created by applying the correction amount B at the start of the print job with the temperature as the correction amount at 28° C.

In the image forming apparatus 1 according to Exemplary Embodiment 2, the temperature inside the image forming portion 3 is detected by the temperature sensor 110, and the correction amount is selected based on the temperature detected by the temperature sensor 110. Accordingly, the image can be formed by applying the correction amount corresponding to the temperature inside the image forming portion 3, and occurrence of the misregistration or the size deviation in the image can be reduced.

### Modification Example of Exemplary Embodiment 2

The image forming apparatus 1 according to Exemplary Embodiment 2 is configured such that the temperature inside the image forming portion 3 is actually detected by the temperature sensor 110, and the correction amount is selected with reference to the temperature-correction amount lookup table (LUT). Thus, as illustrated in FIG. 17, a cost of the image forming apparatus 1 according to Exemplary Embodiment 2 is increased by disposing the temperature sensor 110 in the image forming portion 3.

A modification example of Exemplary Embodiment 2 is configured such that the inside temperature of the image forming portion 3 is predicted in accordance with the elapsed time from the end of the previous job without disposing the temperature sensor 110 in the image forming portion 3, and the correction amount is selected with reference to the temperature-correction amount lookup table (LUT) in accordance with the predicted temperature inside the apparatus.

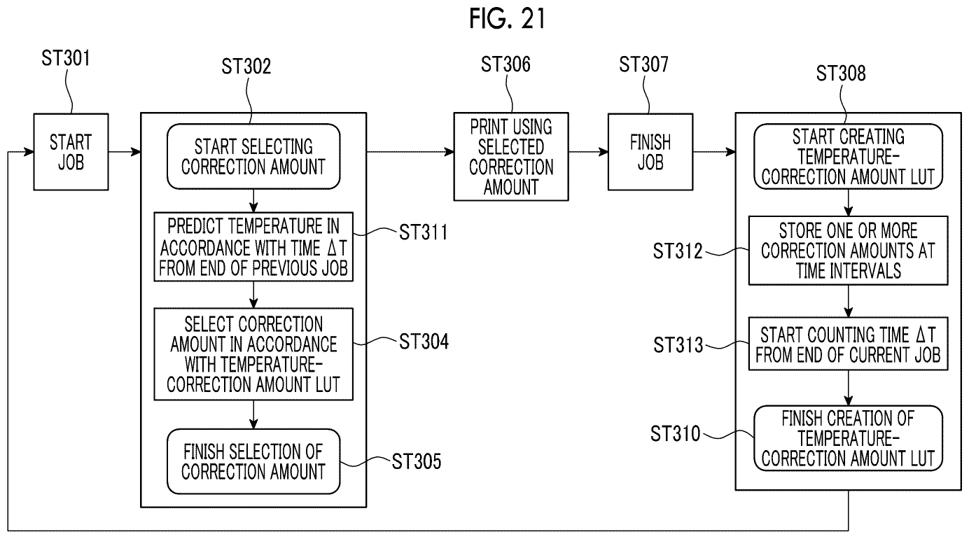

In the image forming apparatus 1 according to the modification example of Exemplary Embodiment 2, as illustrated in FIG. 21, in a case where the CPU 101 starts the selection processing of the correction amount (step S302), the elapsed time ΔT from the end of the previous job is tracked by the timer circuit 108.

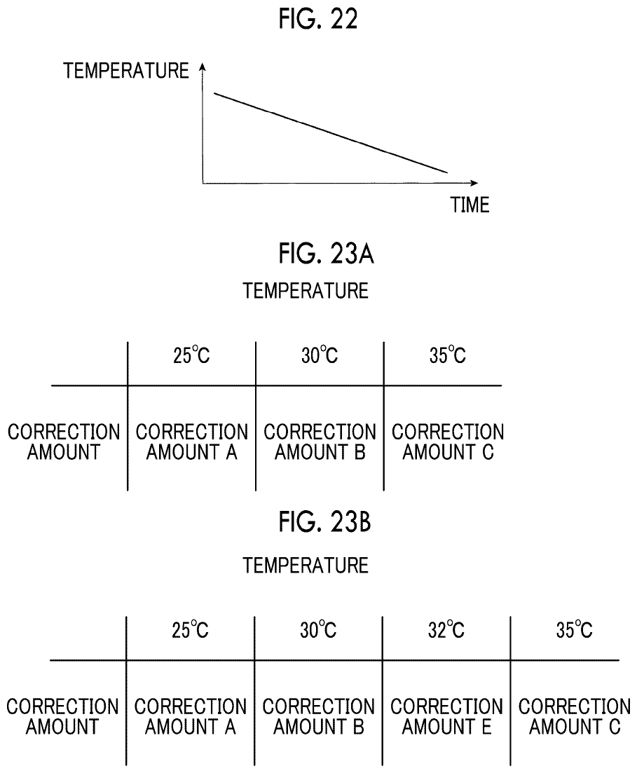

The CPU 101, as illustrated in FIG. 22, predicts the temperature inside the image forming portion 3 in accordance with the elapsed time ΔT from the end of the previous job (step S311). Next, as illustrated in FIGS. 23A and 23B, the CPU 101 selects the correction amount with reference to the temperature-correction amount lookup table in accordance with the predicted temperature inside the image forming portion 3 (step S304) and finishes the selection processing of the correction amount (step S305).

Then, the CPU 101 executes the print operation using the selected correction amount at the end of the previous job (step S306) and finishes the job (step S307).

The CPU 101 starts creating the temperature-correction amount lookup table (LUT) (step S308). The CPU 101 stores one or more correction amounts at time intervals such that the elapsed time varies (step S312), starts counting the time ΔT from the end of the current job (step S313), and finishes creation of the temperature-correction amount lookup table (LUT) (step S310).

Here, in a case where the elapsed time ΔT tracked by the timer circuit 108 is, for example, a time corresponding to 32° C. as the temperature inside the image forming portion 3, the correction amount B at 30° C. in the temperature-correction amount lookup table (LUT) illustrated in FIGS. 23A and 23B is applied.

Then, in a case where the print job to which the correction amount B at 30° C. is applied is finished, the CPU 101, as illustrated in FIG. 23B, updates and creates the temperature-correction amount lookup table (LUT) by associating a new correction amount E obtained using the misregistration detection pattern 201 created by applying the correction amount B at the start of the print job with the temperature as the correction amount at 32° C.

In the image forming apparatus 1 according to the modification example of Exemplary Embodiment 2, the temperature inside the image forming portion 3 is predicted in accordance with the elapsed time ΔT from the end of the previous job, and the correction amount is selected based on the predicted temperature inside the image forming portion 3. Accordingly, the image can be formed by applying the correction amount corresponding to the temperature inside the image forming portion 3 without newly adding a temperature sensor that detects the temperature inside the image forming portion 3, and occurrence of the misregistration or the size deviation in the image can be reduced.

Other configurations and actions are the same as Exemplary Embodiment 1 and thus, will not be described.

While the exemplary embodiments describe the color image forming apparatus including four image creating devices 10Y, 10M, 10C, and 10K of yellow (Y), magenta (M), cyan (C), and black (K) as the image forming apparatus, the invention is not limited to the exemplary embodiments and can also be applied to a monochrome image forming apparatus including only an image creating device of black (K) as the image forming apparatus.

While the exemplary embodiments illustratively describe the electrophotographic image forming apparatus, the present invention may be applied to an image forming apparatus of a system other than the electrophotographic system. For example, the invention may be applied to an image forming apparatus of an ink jet system.

While the exemplary embodiments describe processing performed by executing a program stored in a storage portion, the invention is not limited to the exemplary embodiments, and the processing of the program may be implemented by hardware.

### SUPPLEMENTARY NOTE

(((1)))

An image forming apparatus comprising:
an image forming unit that forms an image on a recording medium under a predetermined condition;
a correction unit that obtains a correction amount of the condition in accordance with a reading result of the image formed on the recording medium and corrects the condition; and
a storage unit that stores the correction amount,
wherein the storage unit stores the correction amount obtained at a start of a job of the image forming unit and applies the correction amount at a start of a subsequent job.
(((2)))

The image forming apparatus according to (((1))), further comprising:
a tracking unit that tracks an elapsed time from an end of the job to the start of the subsequent job,
wherein the storage unit stores
   a first correction amount obtained at the start of the job, and
   a second correction amount obtained after the start of the job, and
the storage unit applies any of the first correction amount or the second correction amount in accordance with the elapsed time tracked by the tracking unit.
(((3)))

The image forming apparatus according to (((2))),
wherein the second correction amount is a correction amount obtained at the end of the job.
(((4)))

The image forming apparatus according to (((1))), further comprising:
a detection unit that detects a temperature inside the image forming apparatus,
wherein the correction unit, in a case where a difference between a subsequent detection temperature of the detection unit at the start of the subsequent job and a previous detection temperature of the detection unit at a start of a previous job falls within a predetermined range, applies a correction value stored in the storage unit.
(((5)))

The image forming apparatus according to (((4))),
wherein the storage unit further stores the correction amount obtained at an end of the job, and
the correction unit applies a correction value close to a detection temperature of the detection unit at a start of a subsequent operation of forming the image among correction amounts stored in the storage unit.
(((6)))

The image forming apparatus according to (((4))),
wherein the storage unit stores the correction amount at a predetermined timing, and the correction unit selects a correction value to be adopted among correction values stored in the storage unit in accordance with a detection temperature of the detection unit.
(((7)))

The image forming apparatus according to (((2))),
wherein the correction unit predicts the elapsed time of the tracking unit from at least one of the number of recording media on which the image is formed by the image forming unit, or the elapsed time.
(((8)))

An image forming program causing a computer to function as each portion of the
image forming apparatus according to any one of (((1))) to (((7))).
(((9)))

An image forming system comprising:
an image forming unit that forms an image on a recording medium under a predetermined condition;
a correction unit that obtains a correction amount of the condition in accordance with a reading result of the image formed on the recording medium and corrects the condition;
a storage unit that stores the correction amount; and
a processor configured to store the correction amount obtained at a start of a job of the image forming unit in the storage unit and apply the correction amount at a start of a subsequent job.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image on a recording medium under a predetermined condition;
a correction unit that obtains a correction amount of the condition in accordance with a reading result of the image formed on the recording medium and corrects the condition; and
a storage unit that stores the correction amount,
wherein the storage unit stores the correction amount obtained at a start of a job of the image forming unit and applies the correction amount at a start of a subsequent job.

2. The image forming apparatus according to claim 1, further comprising:
a tracking unit that tracks an elapsed time from an end of the job to the start of the subsequent job,
wherein the storage unit stores
a first correction amount obtained at the start of the job, and
a second correction amount obtained after the start of the job, and
the storage unit applies any of the first correction amount or the second correction amount in accordance with the elapsed time tracked by the tracking unit.

3. The image forming apparatus according to claim 2,
wherein the second correction amount is a correction amount obtained at the end of the job.

4. The image forming apparatus according to claim 1, further comprising:
a detection unit that detects a temperature inside the image forming apparatus,
wherein the correction unit, in a case where a difference between a subsequent detection temperature of the detection unit at the start of the subsequent job and a previous detection temperature of the detection unit at a start of a previous job falls within a predetermined range, applies a correction value stored in the storage unit.

5. The image forming apparatus according to claim 4,
wherein the storage unit further stores the correction amount obtained at an end of the job, and
the correction unit applies a correction value close to a detection temperature of the detection unit at a start of a subsequent operation of forming the image among correction amounts stored in the storage unit.

6. The image forming apparatus according to claim 4,
wherein the storage unit stores the correction amount at a predetermined timing, and
the correction unit selects a correction value to be adopted among correction values stored in the storage unit in accordance with a detection temperature of the detection unit.

7. The image forming apparatus according to claim 2,
wherein the correction unit predicts the elapsed time of the tracking unit from at least one of the number of recording media on which the image is formed by the image forming unit, or the elapsed time.

8. A non-transitory computer readable medium storing an image forming program causing a computer to function as each portion of the image forming apparatus according to claim 1.

9. A non-transitory computer readable medium storing an image forming program causing a computer to function as each portion of the image forming apparatus according to claim 2.

10. A non-transitory computer readable medium storing an image forming program causing a computer to function as each portion of the image forming apparatus according to claim 3.

11. A non-transitory computer readable medium storing an image forming program causing a computer to function as each portion of the image forming apparatus according to claim 4.

12. A non-transitory computer readable medium storing an image forming program causing a computer to function as each portion of the image forming apparatus according to claim 5.

13. A non-transitory computer readable medium storing an image forming program causing a computer to function as each portion of the image forming apparatus according to claim 6.

14. A non-transitory computer readable medium storing an image forming program causing a computer to function as each portion of the image forming apparatus according to claim 7.

15. An image forming system comprising:
an image forming unit that forms an image on a recording medium under a predetermined condition;
a correction unit that obtains a correction amount of the condition in accordance with a reading result of the image formed on the recording medium and corrects the condition;
a storage unit that stores the correction amount; and
a processor configured to store the correction amount obtained at a start of a job of the image forming unit in the storage unit and apply the correction amount at a start of a subsequent job.

16. An image forming apparatus comprising:
image forming means for forming an image on a recording medium under a predetermined condition;
correction means for obtaining a correction amount of the condition in accordance with a reading result of the image formed on the recording medium and correcting the condition; and
storage means for storing the correction amount,
wherein the storage means stores the correction amount obtained at a start of a job of the image forming means and applies the correction amount at a start of a subsequent job.
